(19) United States
(12) Patent Application Publication
(10) Pub. No.: US 2025/0356464 A1
(43) Pub. Date: Nov. 20, 2025

(54) METHOD AND APPARATUS WITH VISUAL MEDIUM GENERATION

(71) Applicant: Samsung Electronics Co., Ltd., Suwon-si (KR)

(72) Inventors: Sun Ho KIM, Suwon-si (KR); Myungsub CHOI, Suwon-si (KR); Sehwan KI, Suwon-si (KR); Eunhee KANG, Suwon-si (KR); Jisoo SON, Suwon-si (KR); Hyong Euk LEE, Suwon-si (KR)

(73) Assignee: Samsung Electronics Co., Ltd., Suwon-si (KR)

(21) Appl. No.: 19/088,259

(22) Filed: Mar. 24, 2025

(30) Foreign Application Priority Data
May 14, 2024 (KR) 10-2024-0063381
Jul. 1, 2024 (KR) 10-2024-0086393

(51) Int. Cl. G06T 5/60; G06T 11/60

(52) U.S. Cl. CPC G06T 5/60; G06T 11/60; G06T 2207/20081; G06T 2207/20084

(57) ABSTRACT

A processor-implemented method includes obtaining a plurality of prompts indicating image quality with different levels, and generating a plurality of visual media of the same content corresponding to the respective prompts by applying the obtained prompts to a visual medium generation model, wherein the visual medium generation model is trained based on a loss function related to a level of image quality evaluated for an output visual medium and a level of image quality indicated by an input prompt.

### CROSS-REFERENCE TO RELATED APPLICATIONS

This application claims the benefit under 35 USC § 119 (a) of Korean Patent Application No. 10-2024-0063381, filed on May 14, 2024, and Korean Patent Application No. 10-2024-0086393, filed on Jul. 1, 2024, in the Korean Intellectual Property Office, the entire disclosures of which are incorporated herein by reference for all purposes.

### BACKGROUND

### 1. Field

The following description relates to a method and apparatus with visual medium generation.

### 2. Description of Related Art

A visual medium generation technology is a technology for generating images and/or producing videos using computers. This technology may be used in a variety of fields, and diverse and sophisticated visual media may be generated using machine learning models and generative models. For example, deep learning models suitable for visual medium generation may include generative adversarial networks (GAN), transformer-based models, and diffusion models. The visual medium generation technology may be used in two-dimensional (2D) and three-dimensional (3D) modeling, rendering, animation, movies, games, and simulations related to computer graphics, and may also be used to secure training data of visual medium-related models.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one or more general aspects, a processor-implemented method includes obtaining a plurality of prompts indicating image quality with different levels, and generating a plurality of visual media of the same content corresponding to the respective prompts by applying the obtained prompts to a visual medium generation model, wherein the visual medium generation model is trained based on a loss function related to a level of image quality evaluated for an output visual medium and a level of image quality indicated by an input prompt.

The training of the visual medium generation model may include fine-tuning a previously trained generative model based on the loss function.

The loss function may be determined using a determination network trained to determine a difference between the level of the image quality evaluated for the output visual medium and the level of the image quality indicated by the input prompt.

The prompt may include level information about one or more image quality elements.

A first prompt of the prompts may include first level information about a first image quality element, and a second prompt of the prompts may include second level information about the first image quality element.

A first prompt of the prompts may include level information about a first image quality element, and a second prompt of the prompts may include level information about a second image quality element.

The method may include obtaining training data of a visual medium-based model based on one or more of the prompts and visual media, and training the visual medium-based model based on the training data.

In one or more general aspects, a non-transitory computer-readable storage medium may store instructions that, when executed by one or more processors, configure the one or more processors to perform any one, any combination, or all of operations and/or methods disclosed herein.

In one or more general aspects, a processor-implemented method includes obtaining a plurality of prompts indicating image quality with different levels, generating a plurality of visual media of the same content corresponding to the respective prompts by applying the obtained prompts to a visual medium generation model, generating training data of a visual medium-based model based on one or more of the prompts and visual media, and training the visual medium-based model based on the training data.

The training of the visual medium-based model may include applying the training data to the visual medium-based model and applying the prompts to a generative model, and training the visual medium-based model by on a loss determined based on a result of the applying of the training data to the visual medium-based model and a result of the applying of the prompts to the generative model.

The visual medium-based model may include a model that generates image quality evaluation data of an input visual medium, and the generating of the training data may include generating ground truth (GT) of image quality evaluation data of the visual medium generated in response to each of the prompts by applying each of the prompts to a generative model.

The visual medium-based model may include a model that generates image quality comparative evaluation data of an input visual medium, and the generating of the training data may include generating GT of image quality comparative evaluation data of the visual media by applying the prompts to a generative model.

The visual medium-based model may include a model that generates a visual medium with improved image quality of an input visual medium, the generating of the training data may include generating an image quality improvement prompt for converting a visual medium generated in response to a first prompt into a visual medium corresponding to a second prompt by applying the first prompt and the second prompt of the prompts to a generative model, and the training of the visual medium-based model may include training the visual medium-based model to output a visual medium generated in response to the second prompt based on a visual medium generated in response to the first prompt and the image quality improvement prompt.

The generating of the image quality improvement prompt may include extracting two prompts among the prompts, and generating the image quality improvement prompt for converting a visual medium generated in response to the first prompt indicating relatively lower image quality into a visual medium corresponding to the second prompt indicating relatively higher image quality, based on a relative image quality superiority determination result of the two extracted prompts.

In one or more general aspects, an apparatus includes one or more processors configured to obtain a plurality of prompts indicating image quality with different levels, and generate a plurality of visual media of the same content corresponding to the respective prompts by applying the obtained prompts to a visual medium generation model, wherein the visual medium generation model is trained based on a loss function related to a level of image quality evaluated for an output visual medium and a level of image quality indicated by an input prompt.

For the training of the visual medium generation model, the one or more processors may be configured to fine-tune a previously trained generative model based on the loss function.

The loss function may be determined using a determination network trained to determine a difference between the level of the image quality evaluated for the output visual medium and the level of the image quality indicated by the input prompt.

The one or more processors may be configured to generate training data of a visual medium-based model based on one or more of the prompts and the visual media, and train the visual medium-based model based on the training data.

The visual medium-based model may include a model that generates image quality evaluation data of an input visual medium, and for the generating of the training data, the one or more processors may be configured to generate GT of image quality evaluation data of the visual medium generated in response to each of the prompts by applying each of the prompts to a generative model.

The visual medium-based model may include a model that generates image quality comparative evaluation data of an input visual medium, and for the generating of the training data, the one or more processors may be configured to generate GT of image quality comparative evaluation data of the visual media by applying the prompts to a generative model.

Other features and aspects will be apparent from the following detailed description, the drawings, and the claims.

### BRIEF DESCRIPTION OF THE DRAWINGS

FIG. 1 illustrates an example of an operation of a method of generating a visual medium.

FIG. 2 illustrates an example of a framework of visual medium generation.

FIG. 3 illustrates an example of a method of training a visual medium generation model.

FIG. 4 illustrates an example of a method of training a visual medium-based model.

FIG. 5 illustrates an example of an operation of training an image quality evaluation data generation model.

FIG. 6 illustrates an example of an operation of training an image quality comparative evaluation data generation model.

FIG. 7 illustrates an example of an operation of training an image quality improvement visual medium generation model.

FIG. 8 illustrates an example of a configuration of an apparatus.

Throughout the drawings and the detailed description, unless otherwise described or provided, the same drawing reference numerals will be understood to refer to the same elements, features, and structures. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences within and/or of operations described herein are merely examples, and are not limited to those set forth herein, but may be changed as will be apparent after an understanding of the disclosure of this application, except for sequences within and/or of operations necessarily occurring in a certain order. As another example, the sequences of and/or within operations may be performed in parallel, except for at least a portion of sequences of and/or within operations necessarily occurring in an order, e.g., a certain order. Also, descriptions of features that are known after an understanding of the disclosure of this application may be omitted for increased clarity and conciseness.

In connection with the description of the drawings, like reference numerals may be used for similar or related components. It is to be understood that a singular form of a noun corresponding to an item may include one or more of the things, unless the relevant context clearly indicates otherwise.

As used herein, the term “and/or” includes any one and any combination of any two or more of the associated listed items. The phrases “at least one of A, B, and C”, “at least one of A, B, or C”, and the like are intended to have disjunctive meanings, and these phrases “at least one of A, B, and C”, “at least one of A, B, or C”, and the like also include examples where there may be one or more of each of A, B, and/or C (e.g., any combination of one or more of each of A, B, and C), unless the corresponding description and embodiment necessitates such listings (e.g., “at least one of A, B, and C”) to be interpreted to have a conjunctive meaning.

Although terms such as “first,” “second,” and “third”, or A, B, (a), (b), and the like may be used herein to describe various members, components, regions, layers, or sections, these members, components, regions, layers, or sections are not to be limited by these terms. Each of these terminologies is not used to define an essence, order, or sequence of corresponding members, components, regions, layers, or sections, for example, but used merely to distinguish the corresponding members, components, regions, layers, or sections from other members, components, regions, layers, or sections. Thus, a first member, component, region, layer, or section referred to in the examples described herein may also be referred to as a second member, component, region, layer, or section without departing from the teachings of the examples.

Throughout the specification, when a component or element is described as “on,” “connected to,” “coupled to,” or “joined to” another component, element, or layer, it may be directly (e.g., in contact with the other component, element, or layer) “on,” “connected to,” “coupled to,” or “joined to” the other component element, or layer, or there may reasonably be one or more other components elements, or layers intervening therebetween. When a component or element is described as “directly on”, “directly connected to,” “directly coupled to,” or “directly joined to” another component element, or layer, there can be no other components, elements, or layers intervening therebetween. Likewise, expressions, for example, “between” and “immediately between” and “adjacent to” and “immediately adjacent to” may also be construed as described in the foregoing.

The terminology used herein is for describing various examples only and is not to be used to limit the disclosure. The articles “a,” “an,” and “the” are intended to include the plural forms as well, unless the context clearly indicates otherwise. As non-limiting examples, terms “comprise” or “comprises,” “include” or “includes,” and “have” or “has” specify the presence of stated features, numbers, operations, members, elements, and/or combinations thereof, but do not preclude the presence or addition of one or more other features, numbers, operations, members, elements, and/or combinations thereof, or the alternate presence of an alternative stated features, numbers, operations, members, elements, and/or combinations thereof. Additionally, while one embodiment may set forth such terms “comprise” or “comprises,” “include” or “includes,” and “have” or “has” specify the presence of stated features, numbers, operations, members, elements, and/or combinations thereof, other embodiments may exist where one or more of the state.

Unless otherwise defined, all terms, including technical and scientific terms, used herein have the same meaning as commonly understood by one of ordinary skill in the art to which this disclosure pertains and based on an understanding of the disclosure of the present application. Terms, such as those defined in commonly used dictionaries, should be construed to have meanings matching with contextual meanings in the relevant art and the disclosure of the present application, and are not to be construed to have an ideal or excessively formal meaning unless otherwise defined herein.

The features described herein may be embodied in different forms, and are not to be construed as being limited to the examples described herein. Rather, the examples described herein have been provided merely to illustrate some of the many possible ways of implementing the methods, apparatuses, and/or systems described herein that will be apparent after an understanding of the disclosure of this application. The use of the term “may” herein with respect to an example or embodiment (e.g., as to what an example or embodiment may include or implement) means that at least one example or embodiment exists where such a feature is included or implemented, while all examples are not limited thereto. The use of the terms “example” or “embodiment” herein have a same meaning (e.g., the phrasing “in one example” has a same meaning as “in one embodiment”, and “one or more examples” has a same meaning as “in one or more embodiments”).

Hereinafter, the examples will be described in detail with reference to the accompanying drawings. When describing the examples with reference to the accompanying drawings, like reference numerals refer to like elements and a repeated description related thereto will be omitted.

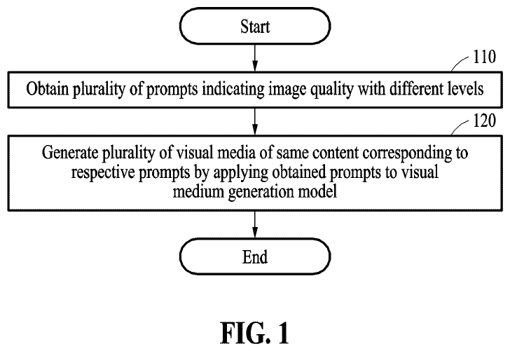

FIG. 1 illustrates an example of an operation of a method of generating a visual medium (e.g., visual content and/or visual data). Operations 110 to 120 to be described hereinafter may be performed sequentially in the order and manner as shown and described below with reference to FIG. 1, but the order of one or more of the operations may be changed, one or more of the operations may be omitted, and two or more of the operations may be performed in parallel or simultaneously without departing from the spirit and scope of the example embodiments described herein.

Referring to FIG. 1, the method of generating a visual medium may include operation 110 of obtaining (e.g., determining and/or generating) a plurality of prompts indicating image quality with different levels. A visual medium (e.g., visual content and/or visual data) may include at least one of an image and/or a video. A video corresponds to a set or sequence of frames corresponding to images, and therefore, the description of the image may also apply to the video in the same manner. Image quality refers to quality of an image of a visual medium and may be indicated or evaluated by various quantitative and/or qualitative indicators. In an example, the image quality may be expressed as image quality elements and may include, for example, at least one of a resolution, a blur value, an illuminance, a contrast, a noise, and/or a color.

Hereinafter, it may be understood that the term referring to prompts or some of prompts (e.g., a prompt, a first prompt, a second prompt, etc.) refers to at least a portion of prompts indicating different levels of image quality, unless explicitly stated that the term refers to a different prompt.

A prompt may include one or more keywords related to image quality elements. For example, the prompt may include information about a style of a color a visual medium (e.g., warm, cool, soft, etc.).

The prompt may include level information about one or more image quality elements. The level information about the image quality elements may include at least one of information indicating a value of an image quality element as a specific range or a specific value and/or information indicating whether a value of an image quality element is high or low. For example, the prompt may include at least one of information indicating whether a resolution of a visual medium to be generated is high or low, information indicating whether a blur value is high or low, and/or information indicating whether an illuminance is high or low. For example, the prompt may include information indicating a quantitative value (e.g., a resolution of 480 p, etc.) of an image quality element of a visual medium to be generated.

The image quality indicated by the prompt may be converted into a level of a quantitative value. For example, the level of image quality may include an image quality assessment (IQA) score.

In an example, the level of image quality indicated by each prompt may be determined by a relative comparison between a plurality of prompts. For example, when a first prompt indicates higher image quality than a second prompt, a level of image quality indicated by the first prompt may be determined to be higher than a level of image quality indicated by the second prompt.

In an example, each of the plurality of prompts may be mapped or classified into one of predetermined levels of image quality according to a predetermined standard. For example, the level of image quality indicated by each prompt may be classified as one of levels 1 to 10, and the level indicates higher image quality as it goes from level 1 to level 10.

The prompts may include different pieces of level information for the same image quality element. In an example, the first prompt among the prompts may include first level information about a first image quality element, and the second prompt among the prompts may include second level information about the first image quality element.

The prompts may include level information for different image quality elements. In an example, the first prompt among the prompts may include level information about the first image quality element, and the second prompt among the prompts may include level information about a second image quality element.

According to an example, the prompts may be obtained (e.g., determined and/or generated) based on a previously trained generative model. A generative model may refer to an artificial intelligence neural network that generates new data (e.g., a text, an image, an audio, or a video) based on a user input (e.g., a text, an image, an audio, or a video). The generative model may include a language generation model. The language generation model (e.g., ChatGPT) may be a model trained to generate a statistically most appropriate output based on an input. The language generation model may include a large language model (LLM) and a large multi-modal model (LMM). An LMM may identify different types of input, such as a text, an image, an audio (e.g., a voice), and/or a visual medium, and generate new data corresponding to the input.

The prompts may be obtained by applying an input requesting the generation of a prompt or a command to indicate the generation of a visual medium of the same content with different image quality to the generative model. Data input to the generative model to obtain the prompts may include type information about an image quality element and range information about a level corresponding to each image quality element.

The prompts may be generated by arbitrarily combining a set of image quality elements and a set of level information. In an example, a prompt including one or more combinations of an image quality element arbitrarily selected from a set of image quality elements and level information arbitrarily selected from a set of level information may be generated. The prompts may also be obtained from a database storing prompts generated to include a combination of level information of various image quality elements. Alternatively, the prompts may be obtained by a user input.

The method of generating a visual medium according to an example may include operation 120 of obtaining (e.g., determining and/or generating) a plurality of visual media of the same content corresponding to the respective prompts by applying the obtained prompts to a visual medium generation model. The visual medium generation model may be a generative model trained to receive a prompt as an input and output a visual medium corresponding to the input prompt. The visual medium generation model may receive one or more prompts as an input, and output a visual medium corresponding to each input prompt. When n prompts are input, the visual medium generation model may output n visual media, and the n output visual media may have the same content and different image quality.

The visual medium generation model according to an example may be trained by the method based on a loss function related to a level of image quality evaluated for the output visual medium and a level of image quality indicated by the input prompt. The visual medium generation model may be trained based on the loss function in such a way that a difference between the level of image quality evaluated for the output visual medium and the level of image quality indicated by the input prompt becomes smaller. For example, the visual medium generation model may be trained based on the loss function to output a visual medium with image quality close to the level of image quality indicated by the input prompt.

In an example, the loss function may be obtained by the method based on a determination network trained to determine a difference between the level of image quality evaluated for the output visual medium and a level of image quality indicated by the input prompt. The determination network may be a neural network trained to estimate a level of image quality of a visual medium output from the visual medium generation model, estimate a level of image quality indicated by a prompt input to the visual medium generation model, and determine a difference between them.

The training of the visual medium generation model may include fine-tuning of a previously trained generative model based on a loss function. The previously trained generative model is a generative model trained to output a visual medium corresponding to an input text, and may include, for example, an LMM, a generative adversarial network (GAN), a variational autoencoder (VAE), a diffusion based generative model having a transformer structure, etc. The visual medium generation model may be a model obtained or trained by fine-tuning a previously trained generative model based on a loss function.

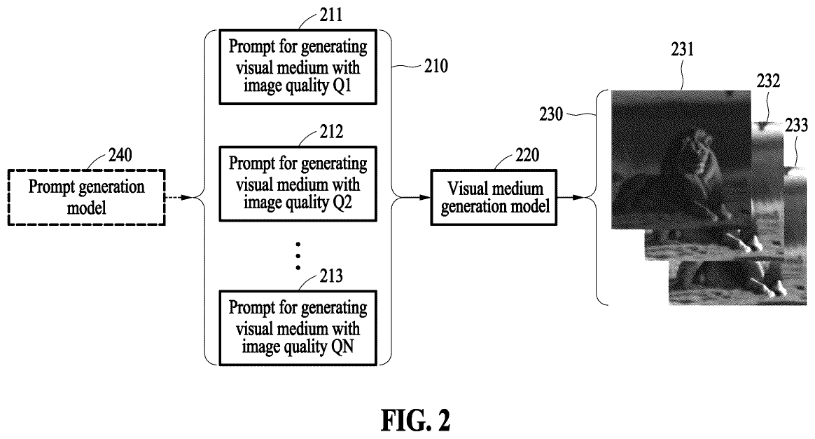

FIG. 2 illustrates an example of a framework of visual medium generation.

Referring to FIG. 2, an input of a visual medium generation model 220 according to an example may include N prompts 210 (where N is a natural number of 2 or more) indicating image quality with different levels. For example, a first prompt 211 may include a prompt for generating a visual medium with image quality Q1, a second prompt 212 may include a prompt for generating an visual medium with image quality Q2, and a third prompt 213 may include a prompt for generating an visual medium with image quality QN (N is a natural number of 3 or more). Q1, Q2, . . . , and QN may refer to levels of image quality. When the level of image quality corresponds to higher image quality from Q1 to Q2, . . . , and QN, the first prompt 211 may include level information (e.g., a low resolution, heavy blur, low illuminance, great noise, low contrast, etc.) of an image quality element corresponding to a low-definition visual medium, and the third prompt 213 may include level information (e.g., a high resolution, no blur, low noise, high contrast, etc.) of an image quality element corresponding to a high-definition visual medium.

The prompts 210 may be obtained from a prompt generation model 240. In an example, the prompt generation model 240 may include a previously trained generative model. In an example, the prompt generation model 240 may include a model obtained by fine-tuning a previously trained generative model. In an example, the prompt generation model 240 may be a model that arbitrarily extracts an image quality element from a set of image quality elements, arbitrarily extracts level information from a set of level information, and generates and outputs a prompt including one or more combinations of the extracted image quality element and level information. In an example, the prompt generation model 240 may be a model that generates and outputs a prompt including level information of one or more image quality elements with reference to a database storing level information items of various image quality elements.

The prompts 210 may include a prompt input by a user.

The visual medium generation model 220 may output visual media 231, 232, and 233 corresponding to each of the input prompts. Visual media 230 output from the visual medium generation model 220 may have the same content and different image quality. The visual medium generation model 220 may output the first visual medium 231 corresponding to the image quality indicated by the first prompt 211. The first visual medium 231 may be a visual medium with lowest image quality among the visual media 230 output from the visual medium generation model 220. The visual medium generation model 220 may output the second visual medium 232 corresponding to the image quality indicated by the second prompt 212. The second visual medium 232 may be a visual medium with higher image quality than the first visual medium 231, and may be a visual medium with lower image quality than the third visual medium 233. The visual medium generation model 220 may output the third visual medium 233 corresponding to the image quality indicated by the third prompt 213. The third visual medium 233 may be a visual medium with highest image quality among the visual media 230 output from the visual medium generation model 220.

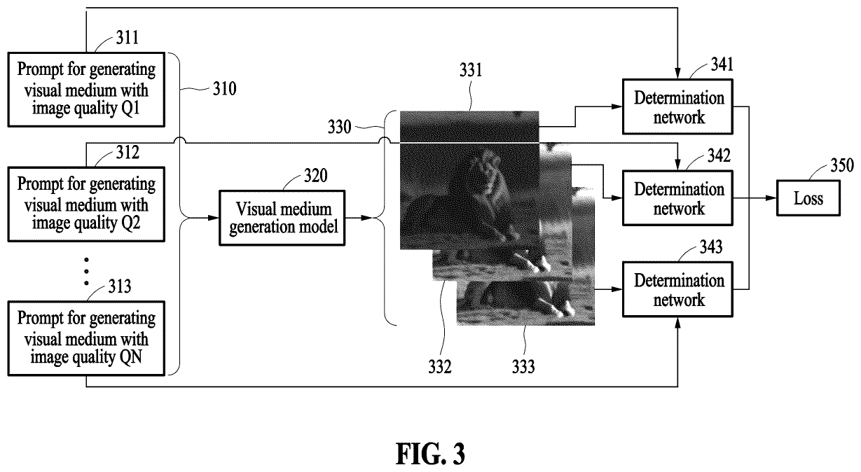

FIG. 3 illustrates an example of a method of training a visual medium generation model.

Referring to FIG. 3, a visual medium generation model 320 according to an example may be trained based on a loss function 350. The visual medium generation model 320 may correspond to the visual medium generation model 220 of FIG. 2.

The loss function 350 may be obtained based on determination networks 341, 342, and 343. As described above, the determination networks 341, 342, and 343 may be neural networks trained to determine a difference between a level of image quality evaluated for an output visual medium and a level of image quality indicated by an input prompt.

The determination network 341 may estimate a level of image quality of a first visual medium 331 output from the visual medium generation model 320 and a level of image quality indicated by a first prompt 311 input to generate the first visual medium 331.

In an example, the determination network 341 may estimate an IQA score of the first visual medium 331 and estimate an IQA score mapped to the first prompt 311. The loss function 350 may be a function related to a difference between the IQA scores of the first visual medium 331 and the first prompt 311.

In an example, the determination network 341 may classify the first visual medium 331 as one of predetermined level types of image quality, and classify the first prompt 311 as one of predetermined level types of image quality. The loss function 350 may be a function related to a difference between the level type of image quality that the first visual medium 331 is classified, and the level type of image quality that the first prompt 311 is classified.

In the same manner as the determination network 341, the determination network 342 may estimate a level of image quality of a second visual medium 332 output from the visual medium generation model 320 and a level of image quality indicated by a second prompt 312 input to generate the second visual medium 332. In the same manner as the determination network 341, the determination network 343 may estimate a level of image quality of a third visual medium 333 output from the visual medium generation model 320 and a level of image quality indicated by a third prompt 313 input to generate the third visual medium 333.

The loss function 350 may be defined as a function related to the difference between the levels of image quality estimated from each of visual media 330 output from the visual medium generation model 320 and each of the prompts 310.

Parameters of the visual medium generation model 320 may be updated based on the loss function 350. In an example, the visual medium generation model 320 may be trained to output a visual medium in which the value of the loss function 350 decreases.

As described above, the prompts 310 may be obtained from a prompt generation model (e.g., the prompt generation model 240 of FIG. 2). The prompt generation model may be a model obtained by fine-tuning a learning model or a previously trained generative model, and in this case, the loss function 350 may also be used for training the prompt generation model. For example, the parameters of the prompt generation model may be updated based on the loss function 350. The prompt generation model may be trained to output a prompt in which the value of the loss function 350 decreases.

FIG. 3 shows the determination networks 341, 342, and 343 corresponding to the respective visual media and prompts as separate components, however, this is for describing an example of a structure of the determination networks 341, 342, and 343 and is not intended to limit the determination networks 341, 342, and 343 to a structure that physically exists in multiple numbers.

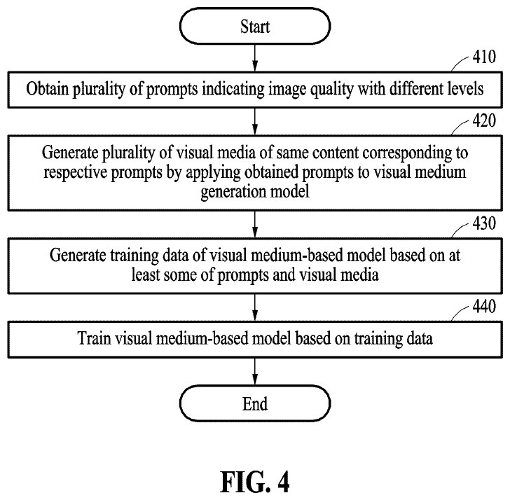

FIG. 4 illustrates an example of a method of training a visual medium-based model. Operations 410 to 440 to be described hereinafter may be performed sequentially in the order and manner as shown and described below with reference to FIG. 4, but the order of one or more of the operations may be changed, one or more of the operations may be omitted, and two or more of the operations may be performed in parallel or simultaneously without departing from the spirit and scope of the example embodiments described herein.

A visual medium-based model according to an example may be a model that generates data about an input visual medium and may be a training-based model. For example, the visual medium-based model may include at least one of a model that outputs text data which is a result of analysis of image quality of an input visual medium and/or a model that outputs a visual medium with changed image quality of the input visual medium.

Referring to FIG. 4, a method of training the visual medium-based model according to an example may include operation 410 of obtaining a plurality of prompts indicating image quality with different levels, and operation 420 of obtaining (e.g., determining and/or generating) a plurality of visual media of the same content corresponding to the respective prompts by applying the obtained prompts to a visual medium generation model. Operations 410 and 420 may correspond to operations 110 and 120 of FIG. 1, respectively.

The method of training the visual medium-based model may include operation 430 of obtaining (e.g., determining and/or generating) training data of the visual medium-based model based on at least some of the prompts and visual media. In an example, the training data of the visual medium-based model may be generated based on at least some of the prompts obtained in operation 410. In an example, the training data of the visual medium-based model may be generated based on at least some of the visual media obtained in operation 420.

The method of training the visual medium-based model may include operation 440 of training the visual medium-based model based on the training data. The training of the visual medium-based model may include applying the training data to the visual medium-based model and applying the prompts to a generative model, and training the visual medium-based model by on a loss determined based on a result of the applying of the training data to the visual medium-based model and a result of the applying of the prompts to the generative model.

According to an example, the visual medium-based model may include a model that generates image quality evaluation data of an input visual medium (e.g., an image quality evaluation data generation model). Hereinafter, the model that generates the image quality evaluation data of the input visual medium may be referred to as the image quality evaluation data generation model.

When the visual medium-based model is the image quality evaluation data generation model, operation 430 of obtaining the training data may include operation of obtaining ground truth (GT) of the image quality evaluation data of the visual medium generated in response to each of the prompts by applying each of the prompts to the generation model.

When the generated visual medium is input in operation 420, the image quality evaluation data generation model may be trained to output GT corresponding to the input visual medium obtained in operation 430.

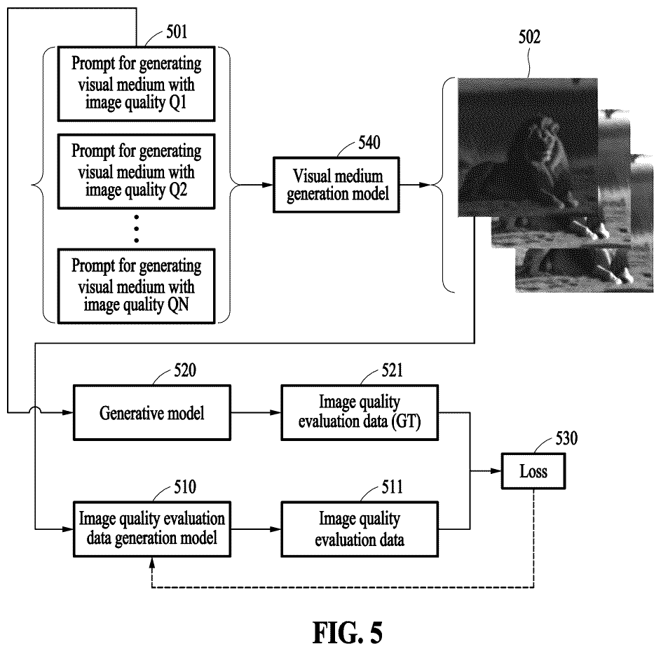

An example of the method of training the image quality evaluation data generation model will be described in detail with reference to FIG. 5 below.

According to an example, the visual medium-based model may include a model that generates image quality comparative evaluation data of an input visual medium. Hereinafter, the model that generates the image quality comparative evaluation data of the visual medium may be referred to as an image quality comparative evaluation data generation model.

When the visual medium-based model is the image quality comparative evaluation data generation model, operation 430 of obtaining the training data may include operation of obtaining GT of the image quality comparative evaluation data of visual media by applying the prompts to the generation model.

When the plurality of visual media generated in operation 420 is input, the image quality comparative evaluation data generation model may be trained to output the GT obtained in operation 430.

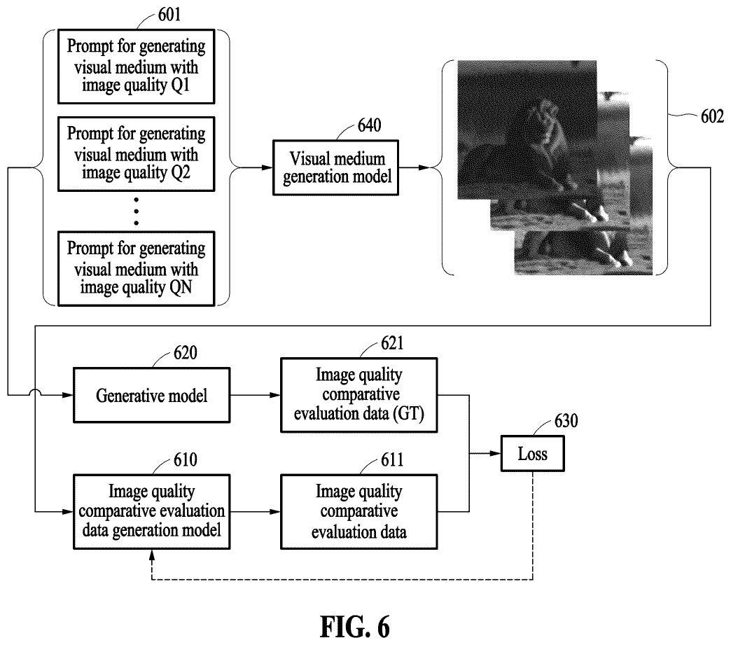

An example of the method of training the image quality comparative evaluation data generation model will be described in detail with reference to FIG. 6 below.

According to an example, the visual medium-based model may include a model that generates a visual medium with improved image quality of an input visual medium. Hereinafter, the model that generates the visual medium with the improved image quality of the input visual medium may be referred to as an image quality improvement visual medium generation model.

When the visual medium-based model is the image quality improvement visual medium generation model, operation 430 of obtaining the training data may include operation of obtaining an image quality improvement prompt for converting a visual medium generated in response to a first prompt into a visual medium corresponding to a second prompt by applying the first prompt and the second prompt of prompts to the generation model. The second prompt may be a prompt indicating a higher level of image quality than the first prompt.

Operation of obtaining the image quality improvement prompt may include operation of extracting two prompts among the prompts. The two extracted prompts may be determined based on a random extraction result. Operation of obtaining the image quality improvement prompt may include operation of obtaining the image quality improvement prompt for converting a visual medium generated in response to the first prompt indicating relatively lower image quality into a visual medium corresponding to the second prompt indicating relatively higher image quality, based on a relative image quality superiority determination result of the two extracted prompts.

When the visual medium-based model is the image quality improvement visual medium generation model, operation 440 of training the visual medium-based model may include operation of training the visual medium-based model to output a visual medium generated in response to the second prompt based on a visual medium generated in response to the first prompt and the image quality improvement prompt. For example, GT of the image quality improvement visual medium generation model corresponding to the visual medium generated in response to the first prompt and the image quality improvement prompt may be the visual medium generated in response to the second prompt. When the visual medium generated in response to the first prompt and the image quality improvement prompt are input, the image quality improvement visual medium generation model may be trained to output the visual medium generated in response to the second prompt.

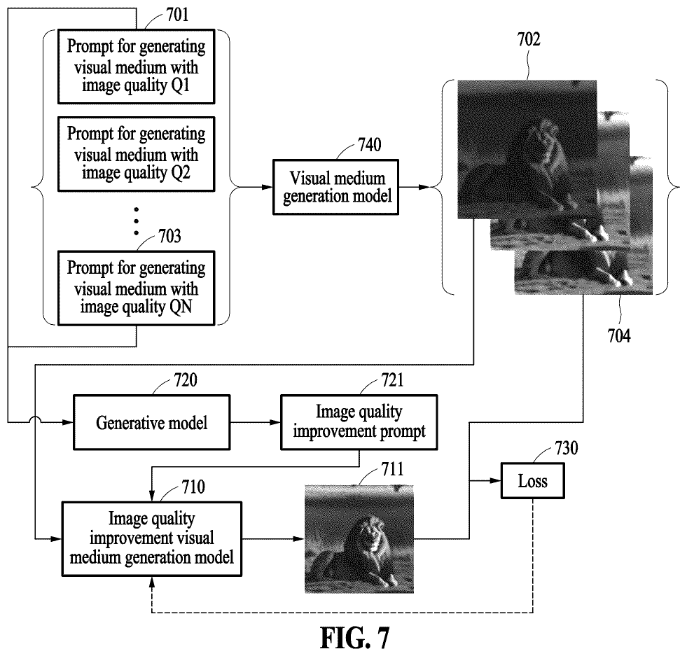

An example of the method of training the image quality improvement visual medium generation model will be described in detail with reference to FIG. 7 below.

FIG. 5 illustrates an example of an operation of training an image quality evaluation data generation model.

A visual medium generation model 540 shown in FIG. 5 may correspond to the visual medium generation model 220 of FIG. 2.

An image quality evaluation data generation model 510 may be a model that receives a visual medium (e.g., a first visual medium 502) as an input and outputs image quality evaluation data 511 of the input visual medium. The image quality evaluation data 511 is text data that includes various analyses or evaluations of image quality of a visual medium, and may include, for example, information indicating various image quality elements that determine the image quality of the visual medium.

GT 521 of image quality evaluation data corresponding to each of the plurality of prompts obtained in operation 110 or 410 may be obtained from a generative model 520. The generative model 520 may be a previously trained generative model and may include, for example, a language generation model.

In an example, a prompt requesting an evaluation result in terms of image quality of a visual medium corresponding to a first prompt 501 (e.g., “There is an image generated with the following prompt. Imagine the generated image and evaluate it in detail in terms of image quality) may be input together with the first prompt 501 to the generative model 520. The GT 521 of the image quality evaluation data of the first visual medium 502 generated in response to the first prompt 501 may be obtained from the generative model 520.

The image quality evaluation data generation model 510 may be trained to receive the first visual medium 502 as an input and output the GT 521 of the image quality evaluation data of the first visual medium 502 obtained from the generative model 520. For example, the image quality evaluation data generation model 510 may be trained to output the image quality evaluation data 511 that has a little difference from the GT 521, based on a loss function 530 for a difference between the GT 521 and the image quality evaluation data 511 output in response to the first visual medium 502.

FIG. 6 illustrates an example of an operation of training an image quality comparative evaluation data generation model.

A visual medium generation model 640 shown in FIG. 6 may correspond to the visual medium generation model 220 of FIG. 2.

An image quality comparative evaluation data generation model 610 may be a model that receives a plurality of visual media 602 as an input and outputs image quality comparative evaluation data 611 of the plurality of visual media 602. The image quality comparative evaluation data 611 is text data that includes results of a relative evaluation by comparing the image quality of visual media, and include, for example, information that ranks or indicates relative superiority in terms of various image quality elements for determining the image quality of visual media.

GT 621 of image quality comparative evaluation data corresponding to a plurality of prompts 601 obtained in operation 110 or 410 may be obtained from a generative model 620. The generative model 620 is a previously trained generative model and may include, for example, a language generation model.

In an example, a prompt requesting a comparative evaluation result in terms of image quality of visual media 602 corresponding to the prompts 601 (e.g., “The followings are prompts used to generate N different images. Imagine the generated images and write an image quality comparative evaluation report”) may be input together with the prompts 601 to the generative model 620. The GT 621 of the image quality comparative evaluation data of the visual media 602 generated in response to the prompts 601 may be obtained from the generative model 620.

The image quality comparative evaluation data generation model 610 may be trained to receive the visual media 602 as an input and output the GT 621 of the image quality comparative evaluation data of the visual media 602 obtained from the generative model 620. For example, the image quality comparative evaluation data generation model 610 may be trained to output the image quality comparative evaluation data 611 that has a little difference from the GT 621, based on a loss function 630 for a difference between the GT 621 and the image quality comparative evaluation data 611 output in response to the visual media 602.

FIG. 7 illustrates an example of an operation of training an image quality improvement visual medium generation model.

A visual medium generation model 740 shown in FIG. 7 may correspond to the visual medium generation model 220 of FIG. 2.

An image quality improvement visual medium generation model 710 may be a model that receives a visual medium (e.g., a first visual medium 702) and an image quality improvement prompt 721 as an input and outputs a visual medium 711 with improved image quality. For example, the image quality improvement visual medium generation model 710 may be a model that outputs the visual medium 711 in which the image quality of the input visual medium (e.g., the first visual medium 702) is improved or enhanced. For example, the image quality improvement visual medium generation model 710 may be a model that outputs the visual medium 711 that is determined that the image quality is improved from the input visual medium (e.g., the first visual medium 702) based on a specific standard (e.g., IQA score, etc.).

The image quality improvement prompt 721 corresponding to two prompts 701 and 703 arbitrarily extracted from among the plurality of prompts obtained in operation 110 or 410 may be obtained from a generative model 720. The generative model 720 is a previously trained generative model and may include, for example, a language generative model. The two arbitrarily extracted prompts 701 and 703 may indicate different levels of image quality, and there may be a relative image quality superiority. For example, the level of image quality indicated by one of the two prompts 701 and 703 may be higher than the level of image quality indicated by the other prompt.

In an example, a prompt requesting an instruction for improving a visual medium with a lower level of image quality among visual media 702 and 704 generated with the two input prompts 701 and 703 into a visual medium with a higher level of image quality (e.g., “Write in detail the instruction for improving a visual medium with lower image quality among the visual media generated with the two prompts into a visual medium with higher image quality”) may be input together with the two prompts 701 and 703 to the generative model 720.

In order to obtain an image quality improvement prompt, a prompt requesting for determining the relative image quality superiority of the two prompts 701 and 703 among the two prompts 701 and 703 (e.g., “Select which one of the two prompts is a prompt with relatively higher image quality based on image quality”) may be input to the generative model 720. Based on the result of the determination of the relative image quality superiority of the two prompts 701 and 703 obtained from the generative model 720, the image quality improvement prompt 721 for converting a visual medium generated in response to the first prompt 701 indicating relatively lower image quality into a visual medium corresponding to the second prompt 703 indicating relatively higher image quality may be obtained.

The image quality improvement visual medium generation model 710 may be trained to receive the first visual medium 702 generated in response to the first prompt 701 and the image quality improvement prompt 721 obtained from the generative model 720 as an input and output a second visual medium 704 generated in response to the second prompt 703. The first visual medium 702 may be a visual medium generated from the visual medium generation model 740 in response to the first prompt 701, and the second visual medium 704 may be a visual medium generated from the visual medium generation model 740 in response to the second prompt 703. The second visual medium 704 may be GT corresponding to the first visual medium 702 and the image quality improvement prompt 721. For example, the image quality improvement visual medium generation model 710 may be trained to output the visual medium 711 that has a little difference from the second visual medium 704, based on a loss function 730 for a difference between the second visual medium 704 which is the GT and the visual medium 711 output in response to the first visual medium 702 and the image quality improvement prompt 721.

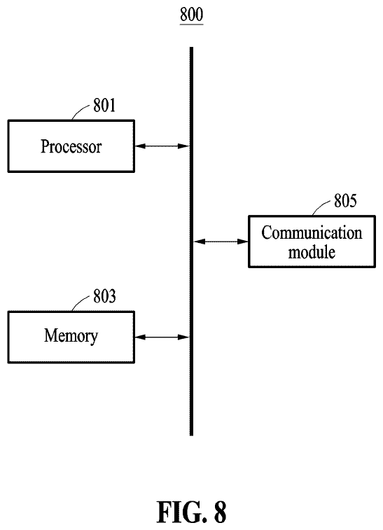

FIG. 8 illustrates an example of a configuration of an apparatus.

Referring to FIG. 8, an apparatus 800 according to an example may include a processor 801 (e.g., one or more processors), a memory 803 (e.g., one or more memories), and a communication module 805. The apparatus 800 may include an apparatus for performing the steps or operations described above with reference to FIGS. 1 to 7.

The processor 801 may perform at least one operation described above with reference to FIGS. 1 to 7. For example, the processor 801 may perform at least one of an operation of obtaining a plurality of prompts indicating image quality with different levels, and an operation of obtaining a plurality of visual media of the same content corresponding to the respective prompts by applying the obtained prompts to a visual medium generation model. For example, the processor 801 may perform at least one of an operation of obtaining training data of a visual medium-based model based on at least some of the prompts and visual media, and training the visual medium-based model based on the training data.

The memory 803 may be a volatile or non-volatile memory and may store data related to the visual medium generation method and/or the method of training the visual medium-based model described above with reference to FIGS. 1 to 7. In an example, the memory 803 may store data generated during the process of performing the visual medium generation method or data required to perform the visual medium generation method. In an example, the memory 803 may store data generated during the process of performing the method of training the visual medium-based model or data required to perform the method of training the visual medium-based model. For example, the memory 803 may store a visual medium generation model, more specifically, parameters of layers in the visual medium generation model.

The communication module 805 may provide a function for the apparatus 800 to communicate with another electronic device or another server through a network. For example, the apparatus 800 may be connected to an external device (e.g., a terminal of a user, a server, or a network) through the communication module 805 and exchange data with the external device.

According to an example, the memory 803 may not be a component of the apparatus 800 and may be included in an external device accessible by the apparatus 800. In this case, the apparatus 800 may receive data stored in the memory 803 included in the external device and transmit data to be stored in the memory 803 through the communication module 805.

According to an example, the memory 803 may store a program configured to implement the visual medium generation method and/or the method of training the visual medium-based model described above with reference to FIGS. 1 to 7. The processor 801 may execute a program stored in the memory 803 and may control the apparatus 800. Code of the program executed by the processor 801 may be stored in the memory 803. For example, the memory 803 may include a non-transitory computer-readable storage medium storing instructions that, when executed by the processor 801, configure the processor 801 to perform any one, any combination, or all of the operations and/or methods described herein with reference to FIGS. 1-7.

The memory 803 may store commands or instructions. For example, the instructions, when executed by the processor 801, may cause the apparatus 800 to perform obtaining a plurality of prompts indicating image quality with different levels, and obtaining a plurality of visual media of the same content corresponding to the respective prompts by applying the obtained prompts to a visual medium generation model. For example, the instructions, when executed by the processor 801, may cause the apparatus 800 to further perform obtaining training data of a visual medium-based model based on at least some of the prompts and the visual media, and training the visual medium-based model based on the training data.

The apparatus 800 may further include other components not shown in the drawings. For example, the apparatus 800 may further include an input/output interface including an input device and an output device as means for interfacing with the communication module 805. In addition, for example, the apparatus 800 may further include other components such as a transceiver, various sensors, and a database.

The apparatuses, processors, memories, communication modules, apparatus 800, processor 801, memory 803, and communication module 805 described herein, including descriptions with respect to respect to FIGS. 1-8, are implemented by or representative of hardware components. As described above, or in addition to the descriptions above, examples of hardware components that may be used to perform the operations described in this application where appropriate include controllers, sensors, generators, drivers, memories, comparators, arithmetic logic units, adders, subtractors, multipliers, dividers, integrators, and any other electronic components configured to perform the operations described in this application. In other examples, one or more of the hardware components that perform the operations described in this application are implemented by computing hardware, for example, by one or more processors or computers. A processor or computer may be implemented by one or more processing elements, such as an array of logic gates, a controller and an arithmetic logic unit, a digital signal processor, a microcomputer, a programmable logic controller, a field-programmable gate array, a programmable logic array, a microprocessor, or any other device or combination of devices that is configured to respond to and execute instructions in a defined manner to achieve a desired result. In one example, a processor or computer includes, or is connected to, one or more memories storing instructions or software that are executed by the processor or computer. Hardware components implemented by a processor or computer may execute instructions or software, such as an operating system (OS) and one or more software applications that run on the OS, to perform the operations described in this application. The hardware components may also access, manipulate, process, create, and store data in response to execution of the instructions or software. For simplicity, the singular term “processor” or “computer” may be used in the description of the examples described in this application, but in other examples multiple processors or computers may be used, or a processor or computer may include multiple processing elements, or multiple types of processing elements, or both. For example, a single hardware component or two or more hardware components may be implemented by a single processor, or two or more processors, or a processor and a controller. One or more hardware components may be implemented by one or more processors, or a processor and a controller, and one or more other hardware components may be implemented by one or more other processors, or another processor and another controller. One or more processors, or a processor and a controller, may implement a single hardware component, or two or more hardware components. As described above, or in addition to the descriptions above, example hardware components may have any one or more of different processing configurations, examples of which include a single processor, independent processors, parallel processors, single-instruction single-data (SISD) multiprocessing, single-instruction multiple-data (SIMD) multiprocessing, multiple-instruction single-data (MISD) multiprocessing, and multiple-instruction multiple-data (MIMD) multiprocessing.

The methods illustrated in, and discussed with respect to, FIGS. 1-8 that perform the operations described in this application are performed by computing hardware, for example, by one or more processors or computers, implemented as described above implementing instructions (e.g., computer or processor/processing device readable instructions) or software to perform the operations described in this application that are performed by the methods. For example, a single operation or two or more operations may be performed by a single processor, or two or more processors, or a processor and a controller. One or more operations may be performed by one or more processors, or a processor and a controller, and one or more other operations may be performed by one or more other processors, or another processor and another controller. One or more processors, or a processor and a controller, may perform a single operation, or two or more operations.

Instructions or software to control computing hardware, for example, one or more processors or computers, to implement the hardware components and perform the methods as described above may be written as computer programs, code segments, instructions or any combination thereof, for individually or collectively instructing or configuring the one or more processors or computers to operate as a machine or special-purpose computer to perform the operations that are performed by the hardware components and the methods as described above. In one example, the instructions or software include machine code that is directly executed by the one or more processors or computers, such as machine code produced by a compiler. In another example, the instructions or software includes higher-level code that is executed by the one or more processors or computer using an interpreter. The instructions or software may be written using any programming language based on the block diagrams and the flow charts illustrated in the drawings and the corresponding descriptions herein, which disclose algorithms for performing the operations that are performed by the hardware components and the methods as described above.

The instructions or software to control computing hardware, for example, one or more processors or computers, to implement the hardware components and perform the methods as described above, and any associated data, data files, and data structures, may be recorded, stored, or fixed in or on one or more non-transitory computer-readable storage media, and thus, not a signal per se. As described above, or in addition to the descriptions above, examples of a non-transitory computer-readable storage medium include one or more of any of read-only memory (ROM), random-access programmable read only memory (PROM), electrically erasable programmable read-only memory (EEPROM), random-access memory (RAM), dynamic random access memory (DRAM), static random access memory (SRAM), flash memory, non-volatile memory, CD-ROMs, CD-Rs, CD+Rs, CD-RWs, CD+RWs, DVD-ROMs, DVD-Rs, DVD+Rs, DVD-RWs, DVD+RWs, DVD-RAMs, BD-ROMs, BD-Rs, BD-R LTHs, BD-REs, blue-ray or optical disk storage, hard disk drive (HDD), solid state drive (SSD), flash memory, a card type memory such as multimedia card micro or a card (for example, secure digital (SD) or extreme digital (XD)), magnetic tapes, floppy disks, magneto-optical data storage devices, optical data storage devices, hard disks, solid-state disks, and/or any other device that is configured to store the instructions or software and any associated data, data files, and data structures in a non-transitory manner and provide the instructions or software and any associated data, data files, and data structures to one or more processors or computers so that the one or more processors or computers can execute the instructions. In one example, the instructions or software and any associated data, data files, and data structures are distributed over network-coupled computer systems so that the instructions and software and any associated data, data files, and data structures are stored, accessed, and executed in a distributed fashion by the one or more processors or computers.

While this disclosure includes specific examples, it will be apparent after an understanding of the disclosure of this application that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents.

Therefore, in addition to the above and all drawing disclosures, the scope of the disclosure is also inclusive of the claims and their equivalents, i.e., all variations within the scope of the claims and their equivalents are to be construed as being included in the disclosure.

What is claimed is:

1. A processor-implemented method comprising:
obtaining a plurality of prompts indicating image quality with different levels; and
generating a plurality of visual media of the same content corresponding to the respective prompts by applying the obtained prompts to a visual medium generation model,
wherein the visual medium generation model is trained based on a loss function related to a level of image quality evaluated for an output visual medium and a level of image quality indicated by an input prompt.

2. The method of claim 1, wherein the training of the visual medium generation model comprises fine-tuning a previously trained generative model based on the loss function.

3. The method of claim 1, wherein the loss function is determined using a determination network trained to determine a difference between the level of the image quality evaluated for the output visual medium and the level of the image quality indicated by the input prompt.

4. The method of claim 1, wherein the prompt comprises level information about one or more image quality elements.

5. The method of claim 1, wherein
a first prompt of the prompts comprises first level information about a first image quality element, and
a second prompt of the prompts comprises second level information about the first image quality element.

6. The method of claim 1, wherein
a first prompt of the prompts comprises level information about a first image quality element, and
a second prompt of the prompts comprises level information about a second image quality element.

7. The method of claim 1, further comprising:
obtaining training data of a visual medium-based model based on one or more of the prompts and visual media; and
training the visual medium-based model based on the training data.

8. A non-transitory computer-readable storage medium storing instructions that, when executed by one or more processors, configure the one or more processors to perform the method of claim 1.

9. A processor-implemented method comprising:
obtaining a plurality of prompts indicating image quality with different levels;
generating a plurality of visual media of the same content corresponding to the respective prompts by applying the obtained prompts to a visual medium generation model;
generating training data of a visual medium-based model based on one or more of the prompts and visual media; and
training the visual medium-based model based on the training data.

10. The method of claim 9, wherein the training of the visual medium-based model comprises:
applying the training data to the visual medium-based model and applying the prompts to a generative model; and
training the visual medium-based model by on a loss determined based on a result of the applying of the training data to the visual medium-based model and a result of the applying of the prompts to the generative model.

11. The method of claim 9, wherein
the visual medium-based model comprises a model that generates image quality evaluation data of an input visual medium, and
the generating of the training data comprises generating ground truth (GT) of image quality evaluation data of the visual medium generated in response to each of the prompts by applying each of the prompts to a generative model.

12. The method of claim 9, wherein
the visual medium-based model comprises a model that generates image quality comparative evaluation data of an input visual medium, and
the generating of the training data comprises generating GT of image quality comparative evaluation data of the visual media by applying the prompts to a generative model.

13. The method of claim 9, wherein
the visual medium-based model comprises a model that generates a visual medium with improved image quality of an input visual medium,
the generating of the training data comprises generating an image quality improvement prompt for converting a visual medium generated in response to a first prompt into a visual medium corresponding to a second prompt by applying the first prompt and the second prompt of the prompts to a generative model, and
the training of the visual medium-based model comprises training the visual medium-based model to output a visual medium generated in response to the second prompt based on a visual medium generated in response to the first prompt and the image quality improvement prompt.

14. The method of claim 13, wherein the generating of the image quality improvement prompt comprises:
extracting two prompts among the prompts; and
generating the image quality improvement prompt for converting a visual medium generated in response to the first prompt indicating relatively lower image quality into a visual medium corresponding to the second prompt indicating relatively higher image quality, based on a relative image quality superiority determination result of the two extracted prompts.

15. An apparatus comprising:
one or more processors configured to:
obtain a plurality of prompts indicating image quality with different levels; and
generate a plurality of visual media of the same content corresponding to the respective prompts by applying the obtained prompts to a visual medium generation model,
wherein the visual medium generation model is trained based on a loss function related to a level of image quality evaluated for an output visual medium and a level of image quality indicated by an input prompt.

16. The apparatus of claim 15, wherein, for the training of the visual medium generation model, the one or more processors are configured to fine-tune a previously trained generative model based on the loss function.

17. The apparatus of claim 15, wherein the loss function is determined using a determination network trained to determine a difference between the level of the image quality evaluated for the output visual medium and the level of the image quality indicated by the input prompt.

18. The apparatus of claim 15, wherein the one or more processors are configured to:
generate training data of a visual medium-based model based on one or more of the prompts and the visual media; and
train the visual medium-based model based on the training data.

19. The apparatus of claim 18, wherein
the visual medium-based model comprises a model that generates image quality evaluation data of an input visual medium, and
for the generating of the training data, the one or more processors are configured to generate GT of image quality evaluation data of the visual medium generated in response to each of the prompts by applying each of the prompts to a generative model.

20. The apparatus of claim 18, wherein
the visual medium-based model comprises a model that generates image quality comparative evaluation data of an input visual medium, and
for the generating of the training data, the one or more processors are configured to generate GT of image quality comparative evaluation data of the visual media by applying the prompts to a generative model.
